(19) United States
(12) Patent Application Publication
(10) Pub. No.: US 2026/0369488 A1
(43) Pub. Date: Nov. 19, 2026

(54) PUSH SWITCH

(71) Applicant: ALPS ALPINE CO., LTD., Tokyo (JP)

(72) Inventor: Junichi MIYAMOTO, Miyagi (JP)

(21) Appl. No.: 19/731,935

(22) Filed: Jul. 6, 2026

Related U.S. Application Data
(63) Continuation of application No. PCT/JP2024/041654, filed on Nov. 25, 2024.

(30) Foreign Application Priority Data
Jan. 15, 2024 (JP) 2024-003972

(51) Int. Cl. H01H 13/10; H01H 13/14

(52) U.S. Cl. CPC H01H 13/10; H01H 13/14; H01H 2229/048

(57) ABSTRACT

A push switch includes a housing that includes an accommodating portion, a movable contact member provided inside the accommodating portion, a fixed contact member that includes a fixed contact provided on an inner bottom surface of the accommodating portion so as to face the movable contact member, and an operating member configured to press the movable contact member. The fixed contact includes a peripheral edge portion embedded in the housing. The peripheral edge portion has a stepped shape.

### CROSS-REFERENCE TO RELATED APPLICATIONS

This application is a continuation application of International Application No. PCT/JP2024/041654 filed on Nov. 25, 2024, and designating the U.S., which is based upon and claims priority to Japanese Patent Application No. 2024-003972 filed on Jan. 15, 2024, the entire contents of which are incorporated herein by reference.

### BACKGROUND

### 1. Technical Field

The present invention relates to a push switch.

### 2. Description of Related Art

International Publication No. WO 2018/142752 (hereinafter “Patent Document 1”) discloses a push switch in which through-holes are formed in a resin member on the rear side of a central fixed contact portion by support pins used during insert molding of the central fixed contact portion. In the push switch, a bent portion is provided at an end of the central fixed contact portion to suppress wetting and spreading of flux, which enters through the through-holes during soldering, toward the front side of the central fixed contact portion.

### SUMMARY

A push switch according to an embodiment includes a housing that includes an accommodating portion, a movable contact member provided inside the accommodating portion, a fixed contact member that includes a fixed contact provided on an inner bottom surface of the accommodating portion so as to face the movable contact member, and an operating member configured to press the movable contact member. The fixed contact includes a peripheral edge portion embedded in the housing. The peripheral edge portion has a stepped shape.

### BRIEF DESCRIPTION OF THE DRAWINGS

FIG. 1 is an external perspective view of a push switch according to an embodiment;

FIG. 2 is an exploded perspective view of the push switch according to the embodiment;

FIG. 3 is a cross-sectional view of the push switch according to the embodiment;

FIG. 4 is an external perspective view of a housing provided in the push switch according to the embodiment;

FIG. 5 is an external perspective view of a first fixed contact member and a second fixed contact member provided in the housing according to the embodiment;

FIG. 6 is a cross-sectional view of the housing provided in the push switch according to the embodiment, taken along A-A; and

FIG. 7 is an external perspective view of the housing provided in the push switch according the embodiment as seen from the bottom surface side.

### DETAILED DESCRIPTION

In the technology of Patent Document 1, there is still a possibility that flux flows around the end portion of the central fixed contact portion and wets and spreads to the front side of the central fixed contact portion. There is therefore room for improvement in the shape of the bent portion of the end portion of the central fixed contact portion.

According to the push switch according to an embodiment disclosed herein, flux flowing around the peripheral edge portion of the fixed contact can be suppressed from entering the front surface side of the fixed contact from the rear surface side.

Hereinafter, an embodiment will be described with reference to the drawings. In the following description, for convenience of explanation, the Z-axis direction in the drawings is defined as the vertical direction, the Y-axis direction is defined as the horizontal direction, and the X-axis direction is defined as the front-rear direction. The positive Z direction is upward, the positive Y direction is rightward, and the positive X direction is forward.

### (Outline of Push Switch 100)

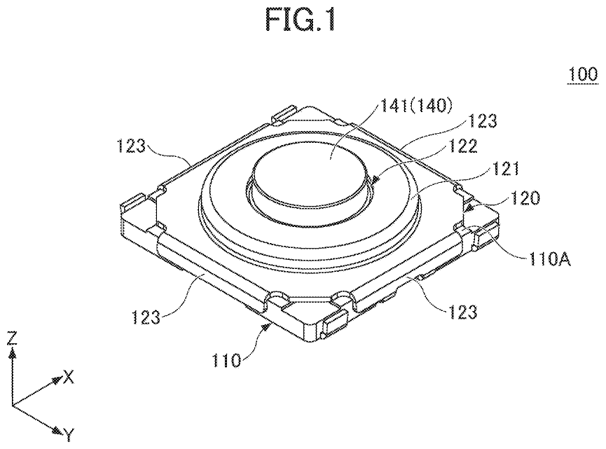

FIG. 1 is an external perspective view of a push switch 100 according to an embodiment. As illustrated in FIG. 1, the push switch 100 is configured such that an upper surface 110A of a housing 110 is covered with a metal cover 120. A projecting portion 121 having a cylindrical shape is formed at the central portion of the metal cover 120, and an opening 122 having a circular shape is formed at the central portion of the projecting portion 121.

An operating portion 141 having a cylindrical shape of a stem 140 penetrates the opening 122 of the metal cover 120 and projects upward (in the positive Z direction) from the metal cover 120. Accordingly, the push switch 100 can be pressed downward (in the negative Z direction) by the operating portion 141 of the stem 140, and switch from an off state to an on state by a pressing operation.

### (Configuration of Push Switch 100)

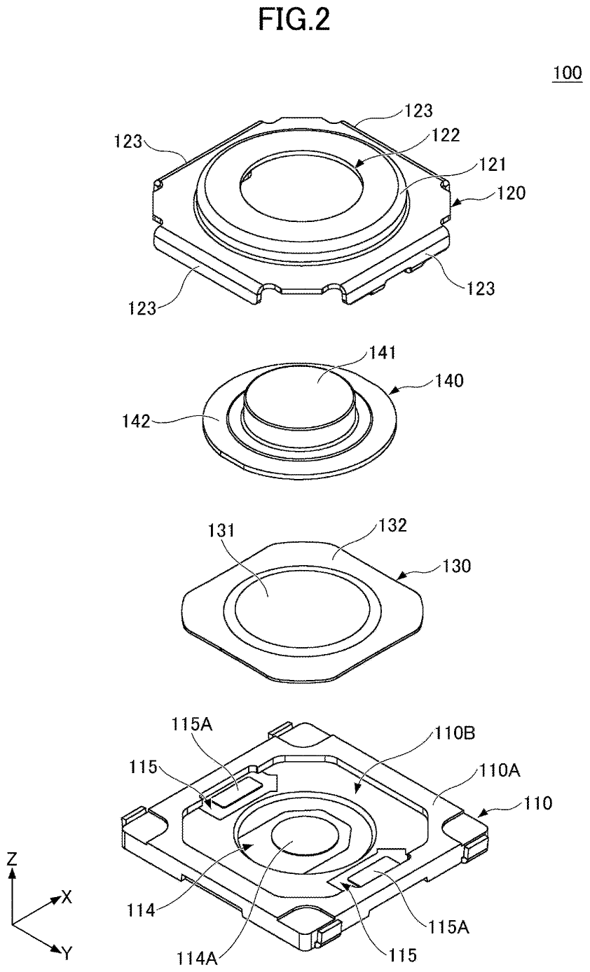

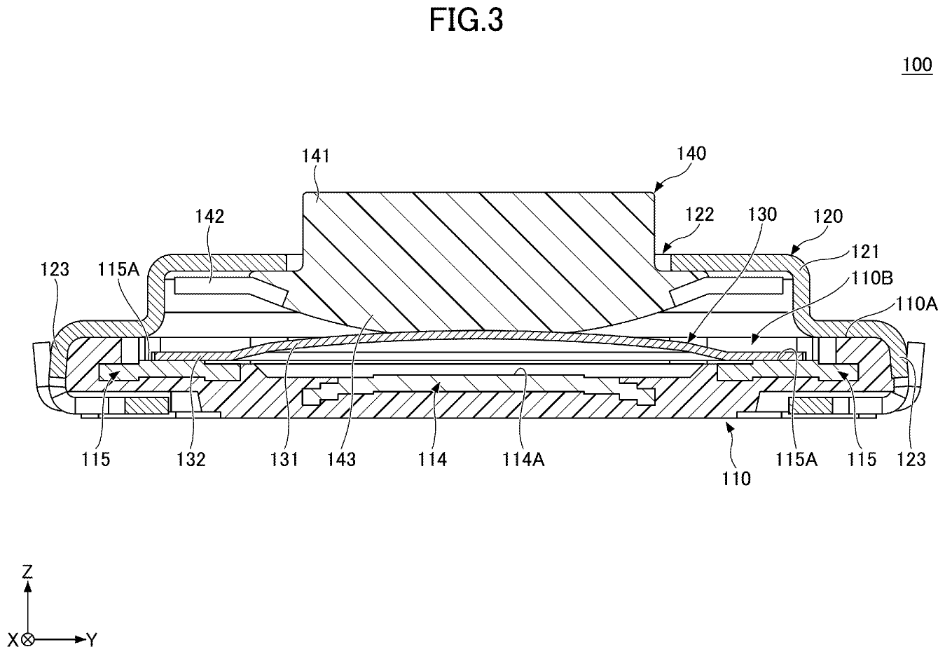

FIG. 2 is an exploded perspective view of the push switch 100 according to the embodiment. FIG. 3 is a cross-sectional view of the push switch 100 according to the embodiment. As illustrated in FIGS. 2 and 3, the push switch 100 includes a housing 110, a movable contact member 130, the stem 140, and the metal cover 120 in order from the lower side (negative Z side) in the drawings.

The housing 110 is a container-shaped member having a thin rectangular parallelepiped shape in the vertical direction (Z-axis direction). The housing 110 has a substantially square shape in a top view. The housing 110 includes an accommodating portion 110B recessed downward from the upper surface 110A. The movable contact member 130 is accommodated in the accommodating portion 110B. For example, the housing 110 is formed by insert molding using a relatively hard insulating material (for example, rigid resin or the like).

A first fixed contact 114 and two second fixed contacts 115 are exposed and provided on the inner bottom surface of the accommodating portion 110B of the housing 110.

The first fixed contact 114 is an example of a “fixed contact”. The first fixed contact 114 is provided at the center of the inner bottom surface of the accommodating portion 110B, and is provided so as to face the rear surface of the apex of the dome portion 131 of the movable contact member 130. The first fixed contact 114 is integrally provided with a first fixed contact member 112 made of a metal and having a plate shape.

The two second fixed contacts 115 are arranged opposite to each other on the inner bottom surface of the accommodating portion 110B, with the first fixed contact 114 being interposed between the two second fixed contacts 115. The two second fixed contacts 115 are integrally provided with a second fixed contact member 113 made of a metal and having a plate shape. A peripheral portion 132 of the movable contact member 130 is placed on the two second fixed contacts 115.

Both the first fixed contact member 112 and the second fixed contact member 113 are formed of a conductive plate material (for example, a metal plate), and are embedded in the housing 110 by insert molding.

The movable contact member 130 is a member made of a thin metal plate and disposed in the accommodating portion 110B of the housing 110. The movable contact member 130 is circular in a top view, and includes a dome portion 131 that is convex in the upward direction (in the positive Z direction). The movable contact member 130 includes the peripheral portion 132 having a horizontal plate shape surrounding the dome portion 131. The peripheral portion 132 has a square outer shape in a top view. The peripheral portion 132 is placed on the two second fixed contacts 115 provided on the inner bottom surface of the accommodating portion 110B. Accordingly, the movable contact member 130 is stably supported at two points by the two second fixed contacts 115 and is electrically connected to the two second fixed contacts 115.

The dome portion 131 of the movable contact member 130 is configured as a snap-action spring. When the operating portion 141 of the stem 140 is pressed, the apex (central portion) is pressed downward by the central protrusion portion 143 of the stem 140, and when a predetermined operating load is exceeded, the apex rapidly elastically deforms into a concave shape (snap action). As a result, the dome portion 131 of the movable contact member 130 comes into contact with the first fixed contact 114 at a portion on the rear side of the apex and is electrically connected to the first fixed contact 114. As a result, the movable contact member 130 can electrically connect the first fixed contact member 112 and the second fixed contact member 113 to each other via the movable contact member 130. The dome portion 131 of the movable contact member 130 is restored to its original convex shape by elastic force when the pressing operation by the operating portion 141 of the stem 140 is released.

The stem 140 is an example of an “operating member” and is a member that is pressed downward by an operator. The stem 140 is disposed inside the projecting portion 121 of the metal cover 120. The stem 140 is formed by using a hard material (e.g. rigid resin, metal, etc.) or an elastic material (for example, rubber, silicone, etc.). The stem 140 includes the operating portion 141, a base portion 142, and a central protrusion portion 143.

The operating portion 141 is provided in the center of the stem 140 and has a cylindrical shape projecting upward from the base portion 142. The operating portion 141 penetrates the opening 122 of the metal cover 120 and is pressed by an operator.

The base portion 142 is a flat and annular portion provided around the operating portion 141. The base portion 142 moves up and down together with the operating portion 141 inside the accommodating portion 110B of the housing 110.

The central protrusion portion 143 is a downward dome-shaped portion that projects downward from the bottom surface of the operating portion 141. When the operating portion 141 is pressed, the central protrusion portion 143 moves downward integrally with the operating portion 141 and the base portion 142 to press the apex of the dome portion 131 of the movable contact member 130.

The metal cover 120 is a metal flat plate member. The projecting portion 121 having a cylindrical shape and projecting upward is formed at the center of the metal cover 120. The stem 140 is disposed inside the projecting portion 121. The opening 122 having a circular shape for allowing the operating portion 141 of the stem 140 to project upward is formed at the center of the projecting portion 121 of the metal cover 120 in a top view. The metal cover 120 is fixedly attached to the upper surface 110A of the housing 110, thereby fixing the stem 140 to the upper surface 110A of the housing 110. Accordingly, the metal cover 120 confines the stem 140 inside the projecting portion 121 and confines the movable contact member 130 to the accommodating portion 110B of the housing 110. For example, the metal cover 120 is formed by machining a metal plate by a machining method such as press machining.

Hooks 123 hanging downward are provided on four sides of the outer peripheral edge portion of the metal cover 120, respectively. The metal cover 120 is positioned and fixed to the housing 110 by engaging each of the four hooks 123 with the side surface of the housing 110.

### (Operation of Push Switch 100)

When a pressing operation by the operating portion 141 of the stem 140 is not performed, the push switch 100 according to an embodiment is in an initial state in which the operating portion 141 is at the highest position and the movable contact member 130 is in an initial state in which the movable contact member protrudes upward. At this time, the movable contact member 130 is in contact with the second fixed contacts 115 but not with the first fixed contact 114. In other words, the second fixed contacts 115 and the first fixed contact 114 are not electrically connected to each other. For this reason, when a pressing operation by the operating portion 141 of the stem 140 is not performed, the push switch 100 according to the embodiment is in an off state.

In the push switch 100 according to the first embodiment, when the operating portion 141 of the stem 140 is pressed, the central protrusion portion 143 of the stem 140 presses down the apex of the dome portion 131 of the movable contact member 130. As a result, the dome portion 131 of the movable contact member 130 is elastically deformed into a concave shape (snap action), and the rear side of the apex of the dome portion 131 of the movable contact member 130 contacts the first fixed contact 114. As a result, in the push switch 100 according to the first embodiment, the first fixed contact 114 and the two second fixed contacts 115 are electrically connected to each other via the movable contact member 130, and the switch is turned on.

### (Configuration of First Fixed Contact Member 112 and Second Fixed Contact Member 113)

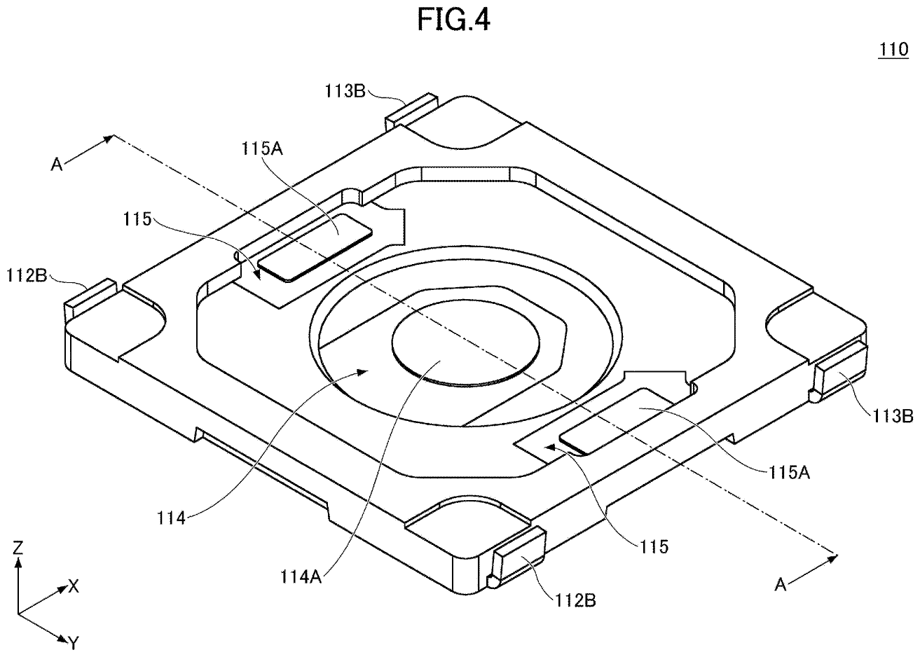

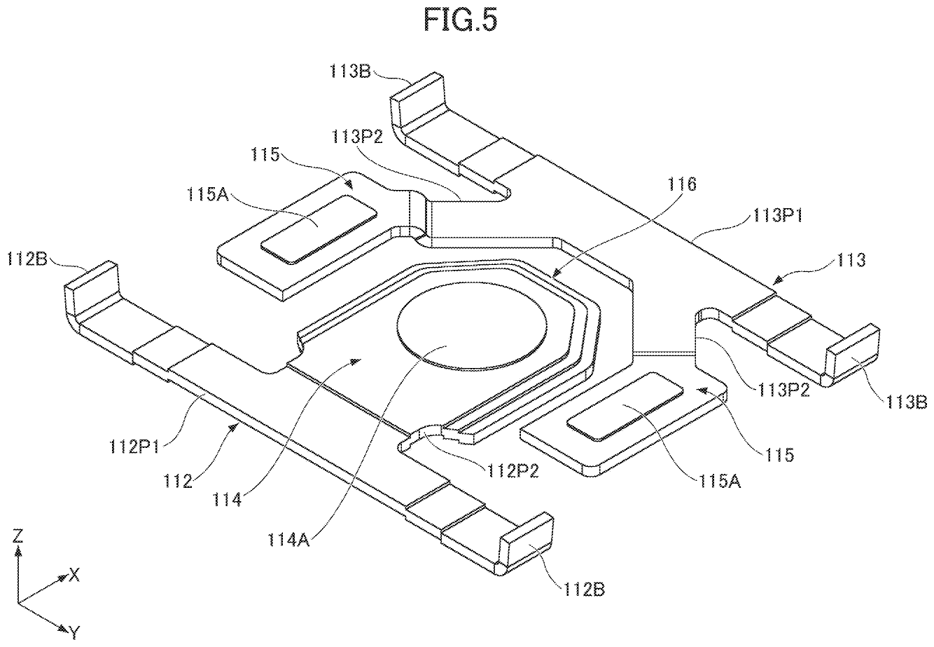

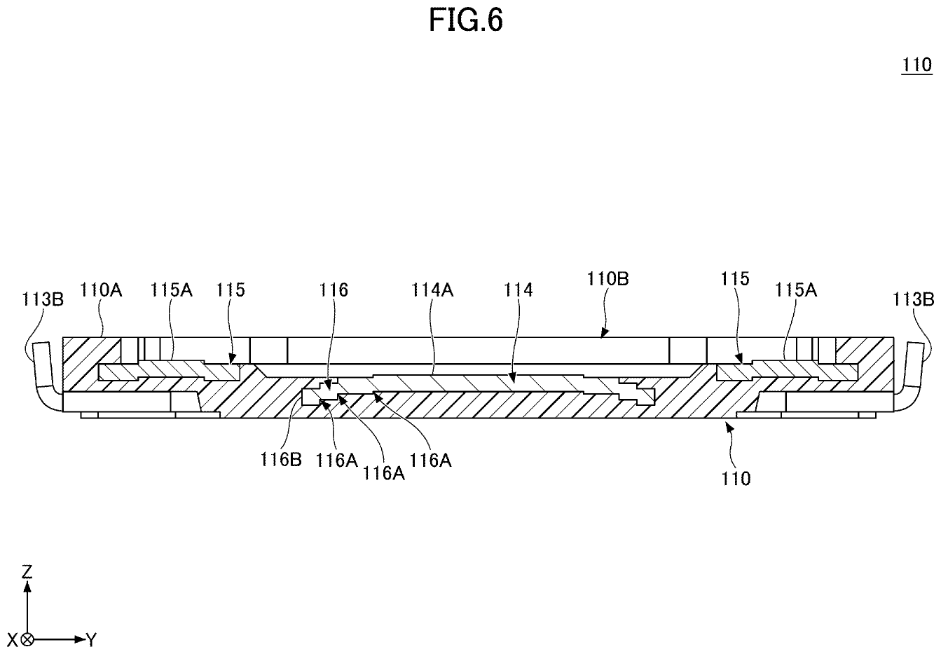

FIG. 4 is an external perspective view of the housing 110 provided in the push switch 100 according to the embodiment. FIG. 5 is an external perspective view of the first fixed contact member 112 and the second fixed contact member 113 provided in the housing 110 according to the embodiment. FIG. 6 is an A-A cross-sectional view of the housing 110 provided in the push switch 100 according to the embodiment.

As illustrated in FIGS. 4 and 5, the housing 110 is integrally provided with the first fixed contact member 112 and the second fixed contact member 113 by insert molding. The first fixed contact member 112 and the second fixed contact member 113 are formed by processing a metal plate. Part of the first fixed contact member 112 and the second fixed contact member 113 is embedded in the housing 110, and the remaining part is exposed from the housing 110.

The first fixed contact member 112 is a metal plate-shaped member provided on the rear side (negative side of the X-axis) of the bottom of the housing 110. The first fixed contact member 112 includes a first portion 112P1 extending linearly in the left-right direction (Y-axis direction), and a second portion 112P2 extending forward (positive X direction) from the center of the first portion 112P1. External connecting terminals 112B are provided at respective ends of the first portion 112P1. The first fixed contact 114 is provided at the distal end of the second portion 112P2.

As illustrated in FIG. 4, the first fixed contact 114 is provided exposed from the resin portion of the housing 110 at the center of the inner bottom surface of the accommodating portion 110B of the housing 110. The first fixed contact 114 faces the rear side of the apex of the dome portion 131 of the movable contact member 130. Accordingly, when the dome portion 131 of the movable contact member 130 is inverted by deformation, the rear side of the apex of the dome portion 131 of the movable contact member 130 comes into contact with the first fixed contact 114, thereby electrically connecting the movable contact member 130 to the first fixed contact 114.

Herein, a contact portion 114A having a pedestal-like shape which is circular in a top view and projects upward is provided on the surface of the first fixed contact 114. For this reason, in the first fixed contact 114, the rear side of the apex of the dome portion 131 of the movable contact member 130 can locally contact the contact portion 114A.

The second fixed contact member 113 is a metal-made, plate-shaped member provided on the front side (positive side of the X-axis) of the bottom of the housing 110. The second fixed contact member 113 includes a first portion 113P1 extending linearly in the left-right direction (Y-axis direction), and a pair of second portions 113P2 extending backward (negative direction of the X-axis) and obliquely from the center of the first portion 113P1. External connecting terminals 113B are provided at respective ends of the first portion 113P1. The second fixed contacts 115 are provided at respective distal ends of the pair of second portions 113P2.

As illustrated in FIG. 4, the pair of left and right second fixed contacts 115 are disposed on the inner bottom surface of the accommodating portion 110B of the housing 110 to face each other in the left and right direction (Y-axis direction), with the first fixed contact 114 interposed between the second fixed contacts 115. Furthermore, the pair of left and right second fixed contacts 115 are exposed from the resin portion of the housing 110. When the movable contact member 130 is disposed in the accommodating portion 110B of the housing 110, the peripheral portion 132 of the movable contact member 130 is placed on the pair of left and right second fixed contacts 115. Accordingly, the pair of left and right second fixed contacts 115 are electrically connected to the movable contact member 130.

Herein, a pedestal-shaped contact portion 115A projecting upward and having a rectangular shape in a top view is provided on the surface of each second fixed contact 115. For this reason, in the second fixed contacts 115, the rear surface of the peripheral portion 132 of the movable contact member 130 can locally contact the contact portions 115A.

Herein, as illustrated in FIGS. 5 and 6, the first fixed contact 114 includes a peripheral edge portion 116 having a stepped shape that decreases in height outwardly. As illustrated in FIGS. 4 and 6, the peripheral edge portion 116 is embedded in the resin portion of the housing 110.

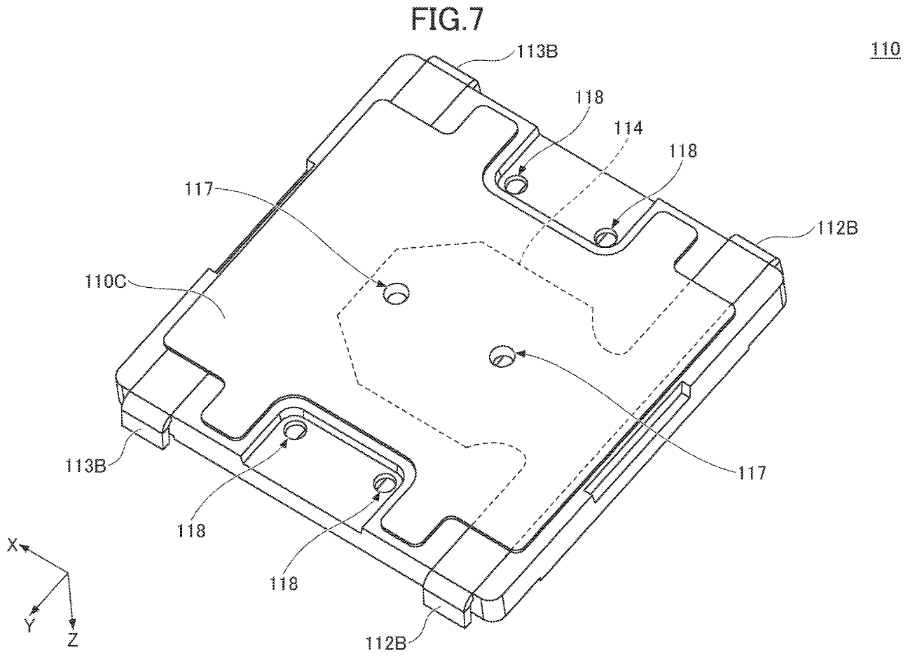

Accordingly, the push switch 100 according to the embodiment can suppress flux flowing around the peripheral edge portion 116 from entering the front surface side of the first fixed contact 114 from the rear surface side even when the flux enters the rear surface side of the first fixed contact 114 through holes 117 of the housing 110 (see FIG. 7).

More specifically, as illustrated in FIG. 6, the rear surface of the peripheral edge portion 116 has a stepped shape descending outwards. In other words, the peripheral edge portion 116 includes a plurality of right-angled step portions 116A (three step portions 116A in the example illustrated in FIG. 6) arranged successively outward.

For this reason, flux entering the rear surface side of the first fixed contact 114 through the holes 117 of the housing 110 and flowing along the rear surface of the first fixed contact 114 encounters the vertical surface of the first step portion 116A located at the highest position of the peripheral edge portion 116, thereby preventing further outward flow of the flux.

Even if the flux overcomes the first step portion 116A and flows further outward, the flux encounters the vertical surface of the second step portion 116A provided further outward, thereby preventing further outward flow of the flux.

Even if the flux overcomes the second step portion 116A and flows further outward, the flux encounters the vertical surface of the third step portion 116A provided further outward, thereby preventing further outward flow of the flux.

As described above, the rear surface of the peripheral edge portion 116 includes a plurality of right-angle step portions 116A arranged successively outward, and since the outflow of the flux can be prevented by the vertical plane of each step portion 116A, it is difficult for the flux to overcome all of the step portions 116A.

Therefore, the push switch 100 according to the embodiment can suppress flux flowing around a side end surface 116B of the peripheral edge portion 116 from entering the front surface side of the first fixed contact 114.

Similarly to the rear surface, the front surface of the peripheral edge portion 116 also includes a plurality of right-angle step portions 116A arranged successively outward. For this reason, even if the flux flowing around the side end surface 116B of the peripheral edge portion 116 enters the front surface side of the peripheral edge portion 116, the push switch 100 according to the embodiment can suppress the flux from entering the exposed portion of the front surface of the first fixed contact 114 (the portion inside the peripheral edge portion 116) by the plurality of step portions 116A on the front surface of the peripheral edge portion 116.

In the present embodiment, the peripheral edge portion 116 has a stepped shape of three steps as an example. However, the present embodiment is not limited to this example, and may have a stepped shape of two steps or four steps or more.

In the present embodiment, the peripheral edge portion 116 is formed in a stepped shape by a semi-piercing operation. Accordingly, in the push switch 100 according to the present embodiment, the plurality of step portions 116A can be collectively formed with respect to the front and rear surfaces of the peripheral edge portion 116, and the plurality of step portions 116A can be formed with high accuracy. For example, in the present embodiment, the squareness of the corner portion (edge portion) of the step portion 116A and the verticality of the vertical surface of the step portion 116A can be improved as compared with a case in which bending working is employed. Therefore, the push switch 100 according to the present embodiment can further enhance the effect of suppressing the outflow of flux by the plurality of step portions 116A. However, this is not limited thereto, and the peripheral edge portion 116 may be formed in a stepped shape by another method (e.g., cutting).

In the present embodiment, as illustrated in FIG. 5, the first fixed contact 114 has a stepped shape across the entire area of the peripheral edge portion 116. Therefore, the push switch 100 according to the present embodiment can obtain the effect of suppressing the outflow of flux over the entire area of the peripheral edge portion 116.

In the present embodiment, since the right angle of the inner corner portion of each step portion 116A is high and the edge is sharp, a gap portion which is not filled with a resin member may be formed in the inner corner portion at the time of insert molding. In this case, the push switch 100 according to the embodiment can further suppress the outflow of flux by allowing the flux to accumulate in the gap.

### (Configuration of Bottom Surface Side of Housing 110)

FIG. 7 is an external perspective view of the push switch 100 according to the embodiment as seen from the bottom surface side of the housing 110.

As illustrated in FIG. 6, in a portion of a bottom surface 110C of the housing 110 which overlaps the rear surface of the first fixed contact 114, two holes 117 which are traces of fixing pins for fixing the first fixed contact 114 during insert molding are formed.

Similarly, in a portion of the bottom surface 110C of the housing 110 which overlaps the rear surface of the second fixed contacts 115, two holes 118 which are traces of fixing pins for fixing the second fixed contacts 115 during insert molding are formed.

Herein, the holes 117 penetrate the bottom surface 110C of the housing 110 in the vertical direction. For this reason, in the housing 110 of the present embodiment, when the housing 110 is soldered to a substrate, there is a possibility that flux may enter the rear surface side of the first fixed contact 114 through the holes 117.

However, in the housing 110 of the present embodiment, since the

rear surface of the peripheral edge portion 116 of the first fixed contact 114 includes the plurality of step portions 116A arranged successively outward, as described above, even when flux enters the rear surface side of the first fixed contact 114 through the holes 117, it is possible to suppress flux flowing around the side end surface 116B of the peripheral edge portion 116 from entering the front surface side of the first fixed contact 114.

Although one embodiment of the present disclosure has been described in detail above, the present disclosure is not limited to the embodiment, and various modifications and alterations are possible within the scope of the present disclosure described in the appended claims.

What is claimed is:

1. A push switch comprising:
a housing that includes an accommodating portion;
a movable contact member provided inside the accommodating portion;
a fixed contact member that includes a fixed contact provided on an inner bottom surface of the accommodating portion so as to face the movable contact member; and
an operating member configured to press the movable contact member, wherein
the fixed contact includes a peripheral edge portion embedded in the housing, and
the peripheral edge portion has a stepped shape.

2. The push switch according to claim 1, wherein
the peripheral edge portion has the stepped shape that includes a plurality of right-angled step portions arranged successively outward.

3. The push switch according to claim 1, wherein
the peripheral edge portion is formed in the stepped shape by a semi-piercing operation.

4. The push switch according to claim 1, wherein
the fixed contact has the stepped shape throughout the peripheral edge portion.

5. The push switch according to claim 1, wherein
a hole, which is a trace of a fixing pin for fixing the fixed contact during insert molding, is formed in a portion of the bottom surface of the housing which overlaps a rear surface of the fixed contact.
